(19) United States
(12) Patent Application Publication
(10) Pub. No.: US 2024/0306661 A1
(43) Pub. Date: Sep. 19, 2024

(54) MOLD-FORMED CONSUMABLE LID AND METHOD OF CONFECTIONERY MANUFACTURE THEREOF

(71) Applicant: KACF LLC, Essex Fells, NJ (US)

(72) Inventor: Albert Tien, Essex Fells, NJ (US)

(73) Assignee: KACF LLC, Essex Fells, NJ (US)

(21) Appl. No.: 18/605,802

(22) Filed: Mar. 14, 2024

Related U.S. Application Data
(60) Provisional application No. 63/452,133, filed on Mar. 14, 2023.

(51) Int. Cl. A23G 1/54; A23G 1/00; B65D 43/02; B65D 51/28; B65D 65/46

(52) U.S. Cl. CPC A23G 1/545; A23G 1/0066; A23G 1/0076; B65D 43/022; B65D 51/28; B65D 65/463; B65D 2251/06; B65D 2543/00305; B65D 2543/00333; B65D 2543/0049

(57) ABSTRACT

Described is an edible lid comprising: a body, formed via a molding process, comprised of one or more primary ingredients, the body comprising: a top portion formed into an improved ice cream swirl shape; a base portion sized to fasten the edible lid to a container, and a hollow cavity, configured to carry a secondary ingredient, formed by an interior of the edible lid.

### FIELD OF INVENTION

The present invention is directed to a confectionery product. More specifically, the present invention is directed to a mold-formed, consumable lid comprised of a confectionery mixture.

### INTRODUCTION

Chocolate, a globally cherished confectionery, is savored by people worldwide. Its history can be traced back to around 1500 BC Mesoamerica, where it held sacred significance as a ceremonial beverage. The introduction of chocolate to Europe took place approximately 3,000 years later, initially serving medicinal purposes. Over time, it was discovered that chocolate could be a delightful treat when sweetened, which transformed its status from a medicine to a luxury confined to Europe's elite. However, the onset of the Industrial Revolution marked a pivotal moment for chocolate, as mass production revolutionized its accessibility. This transformative shift signaled the start of its widespread popularity, transcending its initial role in sacred rituals to become a ubiquitous indulgence across diverse societies worldwide. Presently, chocolate enjoys unprecedented popularity, with approximately $22 billion spent annually on this delectable delight in America alone.

Traditionally, chocolate has been marketed as an individual indulgence for consumption. Prior to its sale, chocolate is typically formed into a shape via a mold. Early attempts at molding chocolate revealed challenges in removing the finalized products from metal molds, which lead to chocolate manufacturers utilizing simple geometric shapes to form their chocolate. To address the issues associated with metal molds, a silver wash was applied to prevent sticking, which in turn allowed for the creation of more intricate shapes. However, the expense of coating molds in silver prompted a shift to a more cost-effective alternative-tin. Eventually, plastic molds emerged as the predominant material for crafting chocolate molds today, supplanting both silver and tin-lined molds.

Despite chocolate's multi-millennia long existence, its primary use by consumers remains unchanged-consumption. While chocolate molding techniques have undergone significant transformations, the application of chocolate has seen minimal innovation, resulting in a lack of creative confectionery developments.

Creative applications of chocolate hold particular appeal for businesses in the dessert industry. Using chocolate as a lid to seal consumable products within a container offers a delectable solution to preserving freshness. A consumable lid, entirely made of chocolate, not only keeps dessert items fresh but also contributes to reducing a business's waste. These lids can be produced through a casting process, wherein they may be filled with a secondary ingredient, eventually enhancing the container's contents. Thus, a chocolate lid serves a dual purpose: preserving the contents within a container and acting as an addition to dessert foods, thereby enhancing the overall experience of indulging in a delightful treat.

Accordingly, it would be desirable to provide consumable lids, as a creative way of keeping food products fresh while simultaneously reducing the amount of waste they produce.

### SUMMARY

This Summary is provided to introduce a selection of concepts in a simplified form that are further described below in the Detailed Description. This Summary is not intended to identify key features or essential features, nor is it intended to limit the scope of the claims included herewith.

Provided may be an edible lid comprised of a body, formed via a molding process, comprised of one or more primary ingredients, the body comprised of a top portion formed into an improved ice cream swirl shape; a base portion sized to fasten the edible lid to a container; and a hollow cavity, configured to carry a secondary ingredient, formed by an interior of the edible lid.

In an embodiment, the molding process comprises the steps of forming a liquid mixture via application of heat to the one or more primary ingredients; pouring the liquid mixture into a first half and a second half of an unjoined mold; joining the first half and the second half of the unjoined mold to form a joined mold; placing the joined mold into a rotocaster; casting, via the rotocaster, the joined mold at a molding rate for a first period of time between 30 and 120 seconds; removing the joined mold from the rotocaster, and allowing said mold to cool for a second period of time; and unjoining the joined mold and ejecting the edible lid

In another embodiment, the edible lid further comprises a lid height of 4.5 inches; and a lid weight between 1.5 and 3.0 ounces. In an additional embodiment, the improved ice cream swirl shape is configured to reduce undercut formation during the molding process. In an alternative embodiment, the molding rate is between 25 and 50 revolutions per minute.

In a further embodiment, the one or more primary ingredients is primarily comprised of a plurality of white chocolate wafers. In an embodiment, the edible lid has a melting point between 17.3° C. and 36.3° C. In yet a further embodiment, the edible lid further comprises a tip disposed at a top of the edible lid, wherein the tip does not curl.

In another embodiment, the molding rate is between 25 and 50 revolutions per minute. Further, the one or more primary ingredients is primarily comprised of white chocolate wafers. In yet a further embodiment, the edible lid has a melting point between 17.3° C. and 36.3° C.

### BRIEF DESCRIPTION OF THE DRAWINGS

The incorporated drawings, which are incorporated in and constitute a part of this specification exemplify the aspects of the present disclosure and, together with the description, explain and illustrate principles of this disclosure.

FIG. 1 illustrates an embodiment of a mold-formed consumable lid.

FIG. 2 illustrates a block diagram of a process for molding the mold-formed consumable lid.

FIG. 3 illustrates a block diagram of a process for tempering one or more primary ingredients.

FIG. 4 illustrates an embodiment of the mold-formed consumable lid disposed within a container.

FIG. 5 illustrates an embodiment of a first half of the mold-formed consumable lid.

FIG. 6 illustrates an embodiment of a second half of the mold-formed consumable lid.

FIG. 7 illustrates an embodiment of an underside of the mold-formed consumable lid.

### DETAILED DESCRIPTION

In the following detailed description, reference will be made to the accompanying drawing(s), in which identical functional elements are designated with like numerals. The aforementioned accompanying drawings show by way of illustration, and not by way of limitation, specific aspects, and implementations consistent with principles of this disclosure. These implementations are described in sufficient detail to enable those skilled in the art to practice the disclosure and it is to be understood that other implementations may be utilized and that structural changes and/or substitutions of various elements may be made without departing from the scope and spirit of this disclosure. The following detailed description is, therefore, not to be construed in a limited sense.

It is noted that description herein is not intended as an extensive overview, and as such, concepts may be simplified in the interests of clarity and brevity.

All documents mentioned in this application are hereby incorporated by reference in their entirety. Any process described in this application may be performed in any order and may omit any of the steps in the process. Processes may also be combined with other processes or steps of other processes.

Disclosed herein is a mold-formed consumable lid and method of confectionery manufacture thereof. In an embodiment, the mold-formed consumable lid may seal the opening of a container. In such an embodiment, the mold-formed consumable lid may increase a shelf life of perishable food items disposed within the container. For example, the mold-formed consumable lid may proscribe the proliferation of bacteria and/or fungi via a reduction in ambient oxygen concentrations within the container. Additionally, the mold-formed consumable lid may enhance the dining experience of a consumer. In an embodiment, the dining experience of the consumer may be enhanced via an ability of the mold-formed consumable lid to be served in at least one of a liquid state and a solid state.

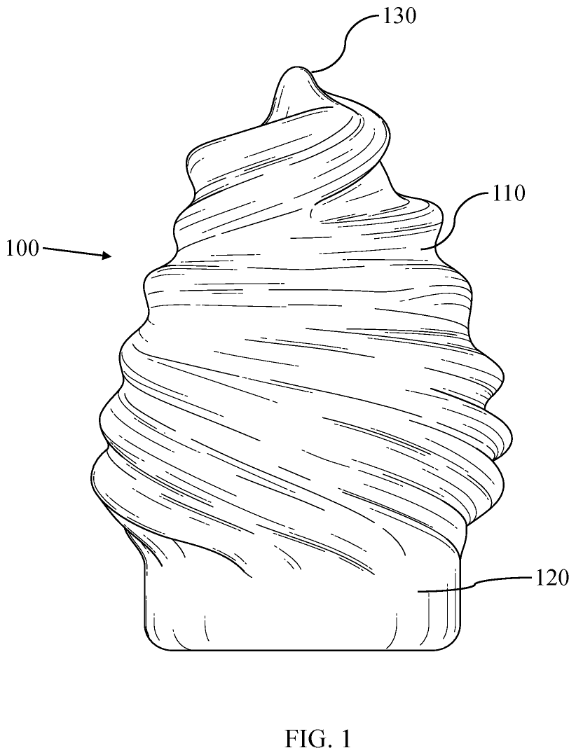

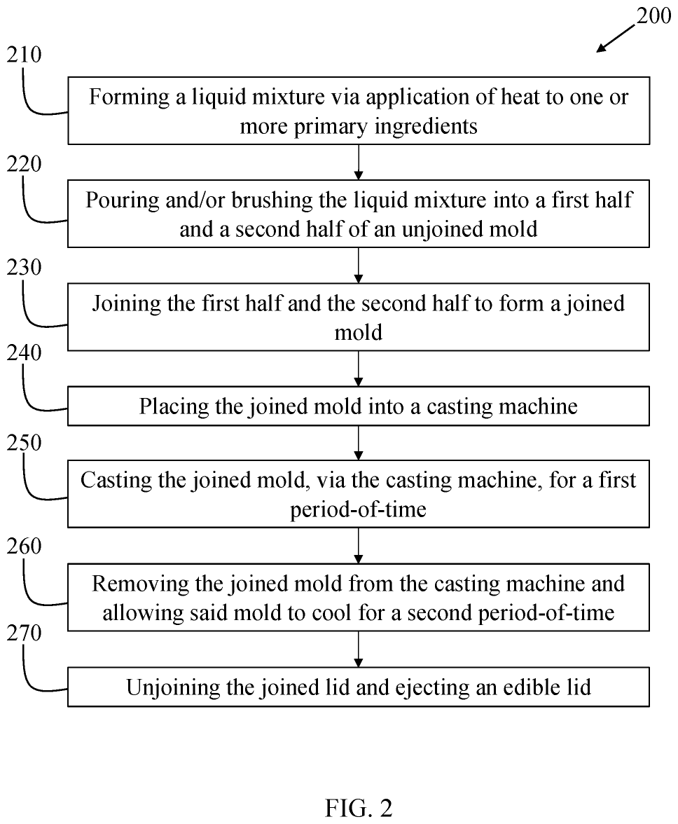

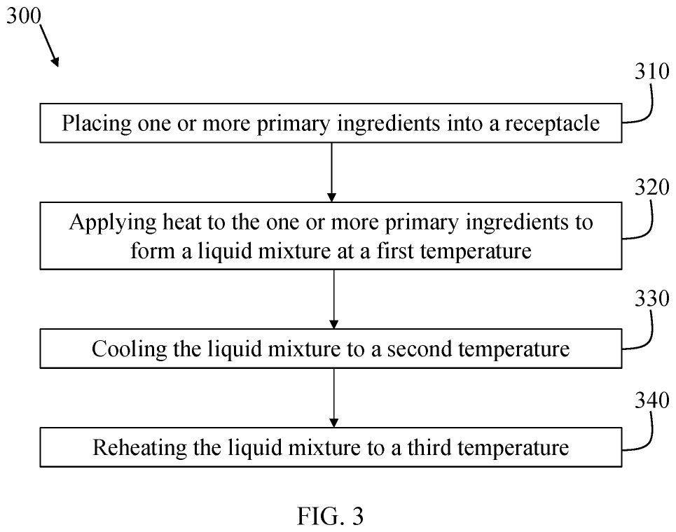

Referring to FIGS. 1-3, the mold-formed consumable lid (hereinafter the “edible lid”) 100 may be comprised of one or more primary ingredients. In an embodiment, the one or more primary ingredients may be comprised of a chocolate mixture. For example, the chocolate mixture may be comprised of a plurality of white chocolate wafers and/or chocolate chips mixed with cocoa butter. In another embodiment, the one or more primary ingredients may be further comprised of food coloring dyes. For example, the combination of the chocolate mixture and the food coloring dyes may enable edible lids 100 of various colors to be produced. As a nonlimiting example, the chocolate mixture may be comprised primarily of white chocolate. In such an example, the white chocolate may assist in the creation of different colored lids due to white chocolate's absence of a hue. Said absence of hue may facilitate more effective color mixing than other types of chocolate such as, dark chocolate or milk chocolate due to a diminished efficacy of food coloring dye mixing via said chocolate type's characteristic colors. The ability for edible lids 100 of various colors to be created enables a consumer to customize said lid 100 for specific occasions. For example, a consumer may desire edible lids for a baby gender reveal party. At such a party, blue or pink food coloring dye may be mixed in with the white chocolate mixture, such that said mixture becomes blue or pink. However, the one or more primary ingredients comprising the edible lid 100 may include any type or category of chocolate or suitable chocolate alternative. In an alternative embodiment, the food coloring dye may be mixed into the chocolate mixture, such that said dye is visibly indiscernible from the chocolate mixture. For example, an interior of the edible lid 100 may be colored with the food coloring dye, whereas an exterior of said lid 100 may be the color of the chocolate comprising the lid 100. In such an example, the food coloring dye may only be visible upon breaking open and/or melting the lid 100. In a further example, the food coloring dye may only become visually apparent after the lid 100 has been utilized to produce a food item or beverage within the container.

The edible lid 100 (described in more detail below) may be formed via a molding process 200. The molding process 200 may be comprised of a first step 210, wherein heat is applied to the one or more primary ingredients to form a liquid mixture. In another embodiment, the first step 210 may employ a tempering process 300 to form the liquid mixture. As a nonlimiting example, the one or more primary ingredients may be solid chocolate, wherein the application of heat melts the chocolate, thus creating the liquid mixture. Furthermore, in the first step 210, the one or more primary ingredients may be tempered, such that the edible lid 100 may have at least one of a smooth and a shiny finish. For example, tempering the liquid mixture may coax fat molecules comprising said mixture to assume a desirable crystalline structure. Whereas a liquid mixture that is not tempered may not assume the desirable crystalline structure, thus rendering said mixture inadequate for molding.

In an embodiment, the one or more primary ingredients may undergo the tempering process 300 to transform said ingredients into the liquid mixture. In a first step 310 of the tempering process, the one or more primary ingredients may be placed into a receptacle. In an embodiment, the receptacle may be a double boiler. In a second step 320 of the tempering process, heat may be applied to the one or more primary ingredients, such that said ingredients melt, thus forming the liquid mixture. In such a step 320, the liquid mixture may be heated to a first temperature. For example, chocolate wafers, within a double boiler, may be heated until said wafers melt and form the liquid mixture. Further, heat may be continuously applied until said liquid mixture is at the first temperature, which may be between 100-120° F. A third step 330 of the tempering process may require the liquid mixture to cool to a second temperature. In another embodiment, while the liquid mixture is cooling, said mixture may need to be stirred. As a nonlimiting example, the melted chocolate wafers may require stirring, as said melted wafers cool to the second temperature between 80-85° F. In a fourth step 340, the liquid mixture, after cooling, may be reheated until said mixture reaches a third temperature. In such a step 340, the melted wafers may need to be heated to the third temperature between 85-90° F. However, any suitable temperature range alternative within the spirit of the disclosure may be utilized for the first, second, and/or third temperature.

In a second step 220 of the molding process 200, the liquid mixture may be poured and/or brushed into a mold. In an embodiment, the food coloring dyes may be mixed into the liquid mixture prior to said mixture being poured and/or brushed into the mold. In another embodiment, the mold may be comprised of a first half and a second half, such that the mold may be unjoined or joined. For example, the first and second half of the mold, while unjoined, may allow the liquid mixture to freely interface with an outside environment. Whereas when joined, the first half may seal the second half, or vice versa, such that the liquid mixture is shielded from the outside environment. Moreover, the liquid mixture may be poured and/or brushed into at least one of the first half and the second half. For example, the first half and the second half may correspond to a right and left side of the edible lid 100, or vice versa. Furthermore, a secondary ingredient may be deposited into at least one of the first half and the second half of the mold. Additionally, the mold may be formed from a mold material. In an embodiment, the mold material may be comprised of at least one of aluminum, polyethylene (PE), polypropylene (PP), nylon, polycarbonate, thermoplastic elastomer (TPE), and silicone.

In a third step 230 of the molding process 200, the first half and the second half of the mold may be joined, such that the liquid mixture is shielded from the outside environment, thus forming the joined mold. In an embodiment, the joined mold may be allowed to cool at air temperature and/or placed into a refrigerator. In such an embodiment, after cooling, the joined mold may be unjoined, so that the edible lid 100 may be removed from the first half or second half of the unjoined mold. Moreover, heat may be applied to edges of the edible lid 100 to enable removal from the mold.

In a fourth step 240 of the molding process 200, the joined mold may be placed into a casting machine. In an embodiment, the casting machine may be a rotocaster, wherein said rotocaster may be manually actuated or motorized. In another embodiment, the joined mold may be allowed to cool, such that the edible lid 100 is formed without need for the casting machine.

The molding process 200 may be further comprised of a fifth step 250, wherein the joined mold may be casted for a first period of time sufficient to form a casted lid. In an embodiment, the first period of time may be any quantity of time sufficient to ensure the liquid mixture solidifies. As a nonlimiting example, the joined mold may be casted for between 30 seconds to 2 minutes at a molding rate between 25-50 revolutions per minute (RPM). Moreover, the first period of time and/or molding rate may depend on at least one of the amount of liquid mixture being molded and the viscosity of said liquid mixture. For example, a large quantity of highly viscous liquid mixture may be casted for 2 minutes at 50 RPM. Whereas a small quantity of liquid mixture with a low viscosity may be casted for 30 seconds. In another embodiment, the first period of time may enable the liquid mixture to evenly coat an interior surface of the joined mold, wherein the even coat may produce an edible lid 100 of uniform thickness. Such a lid 100 may be desirable due to an absence of weak points within the edible lid 100. Meaning, uneven distribution of the liquid mixture within the mold will ultimately produce a lid 100 with uneven walls, thus resulting in sections more susceptible to breakage. In a further embodiment, the joined mold may be casted via at least one of manual actuation and motorized actuation of the casting machine. For example, the rotocaster, holding the joined mold, may be manually actuated for a period of time between 5 and 10 minutes.

In a sixth step 260, the joined mold may be: (1) removed from the casting machine and allowed to cool for a second period of time; or (2) allowed to cool for the second period of time and removed from the casting machine. In such a step 260, the joined mold may be allowed to cool at air temperature and/or placed into a refrigerator, wherein the casted lid within the joined mold may shrink. Treating the joined mold with cold, and thus shrinking the casted lid, may facilitate improved ejection of the edible lid 100 from the joined mold in a seventh step 270 of the process 200. Furthermore, improved ejection of the edible lid 100 may be desirable due to a complexity of the edible lid's 100 geometric shape. For example, the edible lid 100, in a geometric shape of a traditional ice cream swirl, may present difficulties associated with ejection of said lid 100. Thus, cooling the joined mold prior to ejecting the edible lid 100 may allow said lid 100 to decrease in size, which in turn may facilitate the ejection of edible lid 100. As a nonlimiting example, molds formed into a complex shape may pose significant issues with ejection of the final product if said mold is not cooled prior to ejection. In such an example, if the tolerance between the mold and the edible lid 100 is too tight, the lid 100 may fracture during ejection. Thus, cooling the mold, resulting in the mold shrinking, ultimately improves the edible lid's 100 ejectability.

In the seventh step 270 of the molding process 200, the first and second halves, comprising the joined mold may be unjoined, and the edible lid 100 may be ejected from at least one of the first half and the second half of the unjoined mold.

The mold may prevent the formation of undercuts in the edible lid 100, as said lid 100 is ejected from the mold in step seven 270 of the molding process 200. For the purposes of this disclosure, undercuts may be features in a molded part that prevent ejection from the mold. For example, the geometric shape of a traditional ice cream swirl may be comprised of various components, namely sharp edges and an overhanging tip, that render said shape impossible to effectively mold. The mold of the present disclosure is configured to reduce the difficulties associated with molding complex geometric shapes, such as the aforementioned ice cream swirl. In a further embodiment, the mold may reduce and/or prevent the formation of undercuts via a reduction in linear edge formation during the molding process 200, thus forming an improved ice cream swirl shape. As a nonlimiting example, the mold may be formed into a geometric shape, wherein said shape may be the improved ice cream swirl. In such a nonlimiting example, the mold described above may eliminate the overhanging tip associated with traditional ice cream swirls. In the mold used herein, the thematic overall shape of the ice cream swirl may be maintained, while eliminating those features that render molding impossible (i.e., the overhanging tip). The improved ice cream swirl may be a desirable shape in that it produces the illusion the edible lid 100 is comprised of ice cream, while removing the difficulties associated with working with ice cream, namely melting.

The edible lid 100 may be further comprised of a tip 130. In an embodiment, the tip 130 may be disposed upon a top of the edible lid 100, such that said tip 130 forms a peak of the lid 100. In another embodiment, the tip 130 may protrude upwards, such that the tip 130 does not curl. For example, a tip of a traditional ice cream swirl curls downwards and/or in on itself, which is why traditional ice cream swirls cannot be molded with repeatable success. Thus, in an embodiment, the tip 130 does not curl nor does the tip 130 protrude away from the vertical axis of the lid 100, allowing the edible lid 100 to more easily eject from the mold.

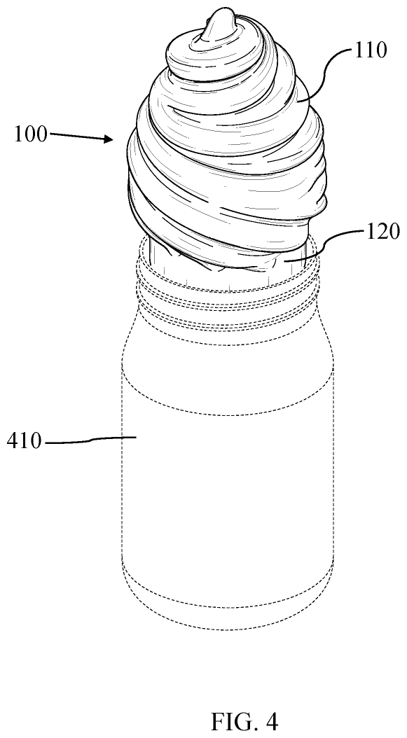

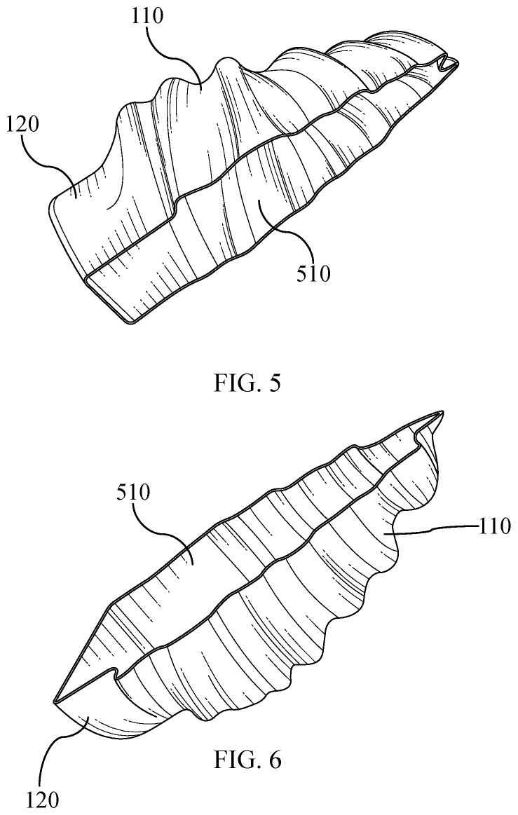

Referring to FIGS. 4-6, the edible lid 100 may be comprised of a body, wherein said body may be comprised of at least one of a top portion 110 and a base portion 120. In an embodiment, the edible lid 100 has at least one of a lid height, a top portion width, a base portion width, and a lid weight. For example, the edible lid 100 may have a lid height of 4.5 inches, a top portion width of 2.6-2.8 inches, a base portion width of 2.2 inches, and a lid weight between 1.5 and 3.0 ounces. In such an example, the width of the top portion 110 may taper from a base to a tip of the top portion 110. In an additional embodiment, the width of the top portion's 110 base may be 2.8 inches, and may taper to a width of between 0.1-0.25 inches at the tip of the top portion 110. However, the lid height, top portion width, base portion width, and lid weight may be any height, width, or weight suitable to enable human consumption. A height of the top portion 110 may be at least three times a height of the base portion 120. Additionally, the top portion width at its widest point may be wider than the base portion width.

In an embodiment, the top portion 110 may be formed into the geometric shape via the mold. The geometric shape may be comprised of any number of three-dimensional shapes. For example, the geometric shape may be comprised of a cube, the improved ice cream swirl, a pyramid, a sphere, etc. The mold utilized in the molding process 200 may be configured to produce the geometric shape.

The edible lid 100 may be further comprised of a hollow cavity 510. In an embodiment, the hollow cavity 510 may be disposed within an interior of at least one of the top portion 110 and the base portion 120. In such an embodiment, the hollow cavity 510 is shielded from the outside environment such that the hollow cavity 510 is completely isolated from the outside environment. The hollow cavity 510 may be formed during the molding process 200. In an embodiment, the hollow cavity 510 may be formed during step five 250 of said process 200. As a nonlimiting example, as the mold is casted the liquid mixture may adhere to one or more sidewalls comprising the mold. Upon adherence to said sidewalls, the liquid mixture may solidify, such that the hollow cavity 510 is formed.

The edible lid may be further comprised of the secondary ingredient. In an embodiment, the secondary ingredient may include candy, cereal, chocolate chips, cocoa mix, coconut flakes, cookies and/or cookie dough, marshmallows, mochi bites, sugar toppers, sprinkles, etc. However, the secondary ingredient may be comprised of any suitable topping alternative (e.g., nuts, peanut butter, pretzels, etc.). In another embodiment, the secondary ingredient may be deposited within the hollow cavity 510. In such an embodiment, a quantity of the secondary ingredient may be deposited in the first half and/or the second half of the unjoined mold, wherein the quantity may be between 0.5-1.5 ounces of secondary ingredient. Meaning, the hollow cavity 510 may be configured to hold 1-3 ounces of the secondary ingredient. However, the quantity of secondary ingredient deposited within the hollow cavity 510, may be any suitable quantity of secondary ingredient capable of filling the entirety of said cavity 510. As a nonlimiting example, the secondary ingredient may be added to the liquid mixture during the molding process 200. In such a nonlimiting example, the secondary ingredient may be fully encapsulated within the hollow cavity 510. In a further nonlimiting example, the secondary ingredient may be embedded within the top portion 110 and/or the base portion 120 of the edible lid 100. In the aforementioned example, the secondary ingredient may be embedded within one or more sidewalls of the top portion 110 and/or base portion 120 during the molding process 200. Traditionally, if secondary ingredient were to be disposed upon the exterior surface of the edible lid 100, the secondary ingredient may be exposed to oxygen and/or prone to being dislodged. Such a configuration is undesirable because a dessert item may lose its visual appeal as a result of the secondary ingredient dislodging from its position.

The base portion 120 may be sized to fit within an opening of a container 410. For example, the base portion 120 may be sized to tightly reside within the opening of the container 410. The base portion 120 may be configured to tightly reside within the opening of the container 410 without said base 120 fracturing as a result of a container tolerance equaling a base portion tolerance. As a nonlimiting example, the base portion 120 may seal the opening of the container such that oxygen is proscribed from entering said container. In an embodiment, the base portion 120 may be friction fit within the opening of the container 410. In another embodiment, the base portion 120 may preserve contents within the container 410 via the base portion's 120 seal in the opening of the container 410. As a further nonlimiting example, the base portion 120 may be friction fit into the opening of a mason jar, wherein the mason jar is filled with a dessert item.

The edible lid 100, via the base portion 120, may seal the opening of the container 410. In an embodiment, the seal created between the edible lid 100 and the opening of the container 410 may prolong a shelf life of the container contents. In such an embodiment, the edible lid 100 may proscribe the proliferation of bacteria and/or fungi via a reduction in ambient oxygen concentrations within the container 410. The edible lid 100 may prevent oxygen from entering the container 410, thus reducing the ambient oxygen concentrations within said container 410. Furthermore, the prolonged shelf life of the container contents may enable said contents to remain shelf stable for periods of time longer than if said contents were not sealed within the container 410 via the edible lid 100. In an alternative embodiment, the base portion 120 may be formed with a diameter and/or circumference sized to tightly reside within the opening of the container 410.

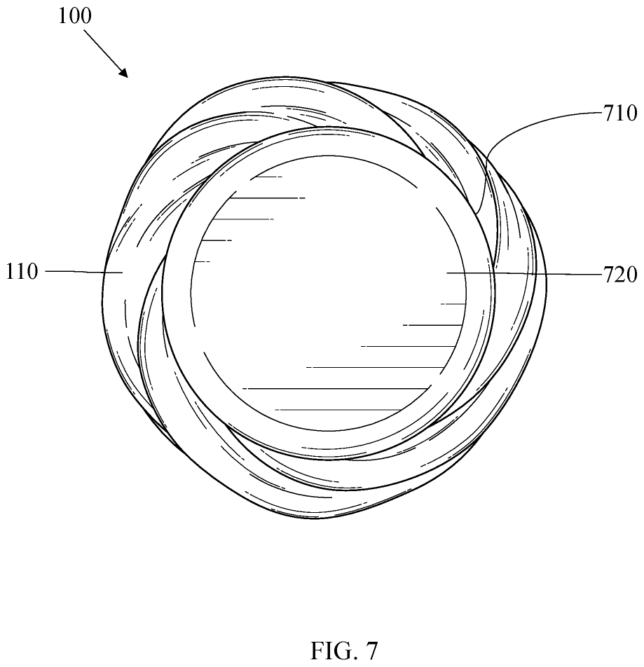

Turning to FIG. 7, the base portion 120 may include a cylindrical sidewall 710 and/or a flat bottom surface 720. In an embodiment, the cylindrical sidewall 710 may be disposed upon a perimeter of the flat bottom surface 720. For example, the base portion 120 may be puck shaped. In another embodiment, flat bottom surface 720 may have a diameter and/or circumference. In such an embodiment, the diameter of the flat bottom surface 720 may equate to the width of the base portion 120. As a nonlimiting example, the diameter and/or circumference may be less than a diameter and/or circumference of an interior surface of the opening of the container 410. Such a nonlimiting example, may enable the base portion 120 to tightly reside within said opening.

The cylindrical sidewall 710 comprising the base portion 120 may be constructed with a height configured to adequately affix the lid 100 to the container 410. For example, the height of cylindrical sidewall may be great enough to prevent the lid 100 from tipping off the container 410 when said container 410 is tilted, angled, or otherwise moved. Accordingly, depending on the height of the edible lid 100, a centroid of the container 410 may be disposed substantially higher than a height of the container 410. Thus, at least one of a tight tolerance formed by the base portion 120 and the container opening, and an anchoring height of the base portion 120, may promote a suitable adherence between the edible lid 100 and the container 410.

Similar to the top portion 110, the base portion 120 may be hollow, thus contributing to the hollow cavity 510, which may enable the base portion 120 and the top portion 110 to store the secondary ingredient via the hollow cavity 510. Additionally, the secondary ingredient may be embedded within one or more sidewalls of the base portion 120 as a second means for carrying the secondary ingredient. Thus, the secondary ingredient may be deposited within the hollow cavity 510 and/or may be embedded in one or more sidewalls comprising the lid 100.

In an embodiment, the edible lid 100 may be removed from the opening of the container 410 and may be combined with the contents of the container 410 and/or a secondary container. Such a lid 100, carrying the secondary ingredient, via the hollow cavity 510, may enable the secondary ingredient, in addition to the edible lid 100 itself, to be combined with the contents of the container 410 and/or a secondary container. As a non-limiting example, the edible lid 100 may have its base portion 120 and top portion 110 removed from the opening of the container 410, wherein the hollow cavity 510, carrying chocolate chips, may be broken open to release said chips into the container 410. In such a nonlimiting example, at least one of the top portion 110 and base portion 120 of the edible lid 100 may be added into the contents of the container 410. In an embodiment, the contents of the container 410 may be the dessert item.

The dessert item may be comprised of a beverage and/or a solid food item. As a nonlimiting example, the dessert item may be hot chocolate and/or a pastry, wherein the pastry may be at least one of one or more slices of cake, one or more cupcakes, one or more donuts, one or more slices of pic, etc.

Additionally, the edible lid 100 may have a melting point. In an embodiment, the melting point may be at a temperature between 17.3° C.-36.3° C. In such an embodiment, the edible lid 100 may transition from a solid state to a liquid state. In another embodiment, the lid 100, while in the liquid state, may form a beverage. Moreover, the secondary ingredient, which may be in the hollow cavity 510, may also be added to the contents of the container 410 when said lid 100 has transitioned from the solid state to the liquid state. In a further embodiment, the edible lid 100, while in the liquid state, may be added to the contents of the container 410. In such an embodiment, the addition of the edible lid 100, while in the liquid state, may create both a beverage and a dessert in said container 410.

In an embodiment, the lid 100 may be added to a hot beverage. In such an embodiment, the edible lid 100 may melt and mix within the container holding said hot beverage. In a further embodiment, a hot beverage may be poured on top of the edible lid 100, disposed within the container 410, such that both the melted lid and the hot beverage mix in the container 410. A ratio between a container volume and the edible lid 100, carrying the secondary ingredient, may exist, such that when said lid 100 is melted, the lid 100 and its contents are configured to fill the entirety of the container volume and/or produce beverage of suitable taste, flavor, and/or consistency. In effect, the edible lid 100 may be sized, such that the volume of ingredients within said lid 100 suitably produces a beverage of a volume approximately that of the container accepting said lid 100.

Finally, other implementations of the disclosure will be apparent to those skilled in the art from consideration of the specification and practice of the disclosure disclosed herein. It is intended that the specification and examples be considered as exemplary only, with a true scope and spirit of the disclosure being indicated by the following claims.

Various elements, which are described herein in the context of one or more embodiments, may be provided separately or in any suitable subcombination. Further, the processes described herein are not limited to the specific embodiments described. For example, the processes described herein are not limited to the specific processing order described herein and, rather, process blocks may be re-ordered, combined, removed, or performed in parallel or in serial, as necessary, to achieve the results set forth herein.

It will be further understood that various changes in the details, materials, and arrangements of the parts that have been described and illustrated herein may be made by those skilled in the art without departing from the scope of the following claims.

All references, patents and patent applications and publications that are cited or referred to in this application are incorporated in their entirety herein by reference. Finally, other implementations of the disclosure will be apparent to those skilled in the art from consideration of the specification and practice of the disclosure disclosed herein. It is intended that the specification and examples be considered as exemplary only, with a true scope and spirit of the disclosure being indicated by the following claims.

What is claimed is:

1. An edible lid comprising:
a body, formed via a molding process, comprised of one or more primary ingredients, the body comprising:
a top portion formed into an improved ice cream swirl shape;
a base portion sized to fasten the edible lid to a container; and
a hollow cavity, configured to carry a secondary ingredient, formed by an interior of the edible lid.

2. The edible lid of claim 1, wherein the molding process comprises the steps of:
forming a liquid mixture via application of heat to the one or more primary ingredients;
pouring the liquid mixture into a first half and a second half of an unjoined mold;
joining the first half and the second half of the unjoined mold to form a joined mold;
placing the joined mold into a rotocaster;
casting, via the rotocaster, the joined mold at a molding rate for a first period of time between 30 and 120 seconds;
removing the joined mold from the rotocaster, and allowing said mold to cool for a second period of time; and
unjoining the joined mold and ejecting the edible lid.

3. The edible lid of claim 1, further comprising:
a lid height of 4.5 inches; and
a lid weight between 1.5 and 3.0 ounces.

4. The edible lid of claim 1, wherein the improved ice cream swirl shape is configured to reduce undercut formation during the molding process.

5. The edible lid of claim 2, wherein the molding rate is between 25 and 50 revolutions per minute.

6. The edible lid of claim 1, wherein the one or more primary ingredients is primarily comprised of a plurality of white chocolate wafers.

7. The edible lid of claim 1 having a melting point between 17.3° C. and 36.3° C.

8. The edible lid of claim 1, further comprising:
a tip disposed at a top of the edible lid,
wherein the tip does not protrude away from a vertical axis of the edible lid.

9. An edible lid comprising:
a body, formed via a molding process, comprised of one or more primary ingredients, the body comprising:
a top portion formed into an improved ice cream swirl shape,
the improved ice cream swirl shape configured to reduce undercut formation during the molding process;
a base portion comprising:
a circular flat bottom surface; and
a cylindrical sidewall disposed upon a circumference of the flat bottom surface;
a hollow cavity, configured to carry a secondary ingredient, formed by an interior of the edible lid;
the molding process comprising:
forming a liquid mixture via a tempering process;
pouring the liquid mixture into a first half and a second half of an unjoined mold,
wherein the first and second halves of the unjoined mold correspond to a first half and a second half of the improved ice cream swirl shape;
joining the first half and the second half of the unjoined mold to form a joined mold;
placing the joined mold into a rotocaster;
casting, via the rotocaster, the joined mold at 25-50 revolutions per minute for a first period of time between 30 and 120 seconds;
removing the joined mold from the rotocaster and allowing said mold to cool for a second period of time; and
unjoining the joined mold and ejecting the edible lid.

10. The edible lid of claim 9, wherein the tempering process comprises:
placing the one or more primary ingredients into a receptacle;
applying heat to the one or more primary ingredients to form the liquid mixture,
the heat bringing the liquid mixture to a first temperature;
cooling the liquid mixture to a second temperature; and
reheating the liquid mixture to a third temperature.

11. The edible lid of claim 10, wherein the first temperature is between 100-120° F., the second temperature is between 80-85° F., and the third temperature is between 85-90° F.

12. The edible lid of claim 9, wherein the hollow cavity is configured to carry between 1-3 ounces of the secondary ingredient.

13. The edible lid of claim 9, wherein the circular flat bottom surface has a diameter of 2.2 inches.

14. The edible lid of claim 13, wherein both the circular flat bottom surface and cylindrical sidewall are friction fit within an opening of a container.

15. The edible lid of claim 9, further comprising:
a lid height of 4.5 inches; and
a lid weight between 1.5 and 3.0 ounces.

16. The edible lid of claim 9, having a melting point between 17.3° C. and 36.3° C.

17. The edible lid of claim 9, further comprising:
a tip disposed at a top of the edible lid,
wherein the tip does not protrude away from a vertical axis of the edible lid.
